(19) United States
(12) Patent Application Publication
(10) Pub. No.: US 2015/0162708 A1
(43) Pub. Date: Jun. 11, 2015

(54) NON-STANDARD SLIM LOCK CONNECTOR SYSTEM

(71) Applicant: VOLEX PLC, London (GB)

(72) Inventors: See Yun Jaan, Singapore (SG); Jessica Toh Mui Lian, Singapore (SG)

(21) Appl. No.: 14/566,646

(22) Filed: Dec. 10, 2014

Related U.S. Application Data
(60) Provisional application No. 61/914,332, filed on Dec. 10, 2013.

(51) Int. Cl. H01R 13/627

(52) U.S. Cl. CPC H01R 13/6272

(57) ABSTRACT

A slim lock connector system comprises an inlet comprising a mating port, first and second power contacts disposed within the mating port, and a ground contact disposed within the mating port. In addition, a connector is configured to be removably engaged with and locked to the inlet via the mating port. The inlet preferably includes a locking structure and recess disposed within the mating port, and the connector preferably includes a housing, release tab, and resilient member coupled to the housing and release tab. The release tab and resilient member are configured such that pressing on the release tab enables the housing to be unlocked from the inlet.

### CROSS REFERENCE TO RELATED APPLICATIONS

This application claims benefit under 35 U.S.C. §119(e) of U.S. Provisional Patent Application No. 61/914,332, filed Dec. 10, 2013, the contents of which are incorporated herein by reference in its entirety.

### TECHNICAL FIELD

The present disclosure relates to couplers for providing an electrical power connection.

### BACKGROUND

Portable electronics devices are increasingly outselling their non-portable counterparts. Although most, if not all, portable electronics devices are built with a battery on board, they still need to connect to a fixed power source occasionally. In cases where an external AC-DC adaptor is used along the power supply line, some manufacturers may choose to link the electronics devices' AC-DC adaptor to the wall socket using a (detachable) power cord. However, as the consumer continues to use the portable electronic device while connected to the fixed power source (via the AC-DC adaptor), moving past the total length of the power supply linkage may in turn pull electrical connection(s) apart and disconnect the power supply.

For grounded portable electronics devices that require only a low current rating and/or for AC-DC adaptors that have small space/low cost requirements, manufacturers often opt for a standard connector, such as International Electrotechnical Commission (IEC) C5 connector and IEC C6 inlet pair. Thus, it would be advantageous to have a locking mechanism between the power cord's connector and the AC-DC adaptor's inlet that is easy to use.

### SUMMARY

The present disclosure aims at overcoming the weaknesses of conventional connectors and providing an electrical power connector with positive locking connector suitable for power connectors. The illustrative embodiment described below provides a connector that incorporates a simple locking mechanism into the connector housing.

An illustrative embodiment of a connector system in accordance with a first aspect of the present disclosure includes an inlet comprising a mating port, first and second power contacts disposed within the mating port, and a ground contact disposed within the mating port. In addition, the system includes a connector configured to be removably engaged with and locked to the inlet via the mating port. Finally, an outer mold is configured to encase the power and ground conductors and wires of a power cable.

An illustrative embodiment of an inlet in accordance with a second aspect of the present disclosure comprises a mating port, and a locking structure and recess disposed within the mating port. In addition, first and second power contacts, as well as a ground contact, are disposed within the mating port.

Finally, an illustrative embodiment of a connector in accordance with a third aspect of the present disclosure comprises a housing, a release tab, and a resilient member. The resilient member is coupled to the housing and the release tab, and the assembly is configured to be removably engaged with an inlet via a mating port of the inlet.

Additional features of the disclosed embodiments are described below.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

### BRIEF DESCRIPTION OF THE DRAWINGS

Embodiments of the present disclosure will be described more fully hereinafter with reference to the accompanying drawings, in which:

FIG. 1 depicts an illustrative embodiment of a slim lock connector system in accordance with the present disclosure. The illustrative system includes a slim lock inlet 110, connector 120, and cable 140.

FIG. 2 provides a sectioned rear view of the slim lock inlet 110.

FIG. 3 depicts another view of the slim lock connector system.

FIG. 4A illustrates steps for engaging the connector 120 and the inlet 110.

FIG. 4B and FIG. 4C illustrate steps for disengaging the connector 120 from the inlet 110.

### DETAILED DESCRIPTION OF ILLUSTRATIVE EMBODIMENTS

While embodiments of an electrical power connector, for convenience and simplicity, are illustrated in the drawings and described herein, it is to be understood that the present disclosure is not limited to electrical power connectors and could equally apply to any type of connector, including data and signal connectors and non-electrical connectors, such as optical connectors.

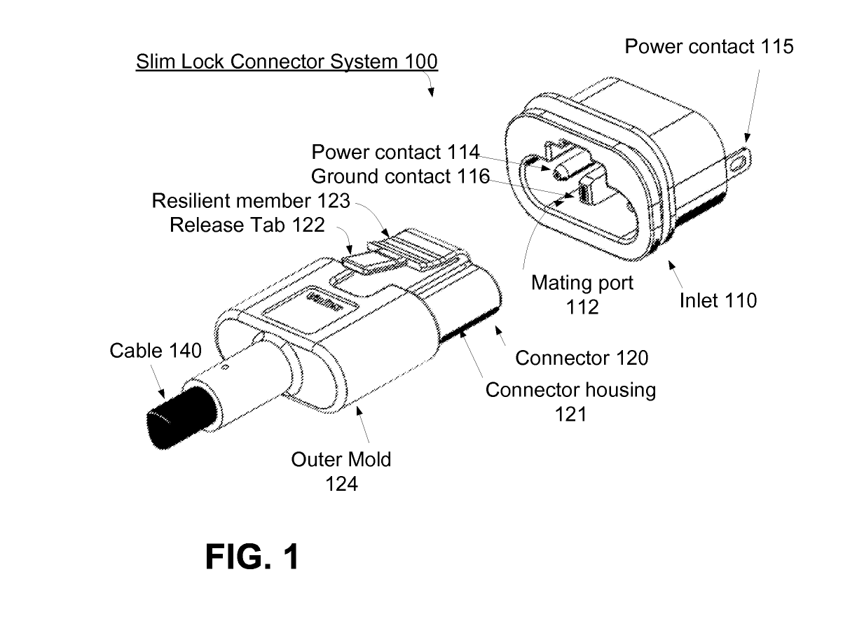

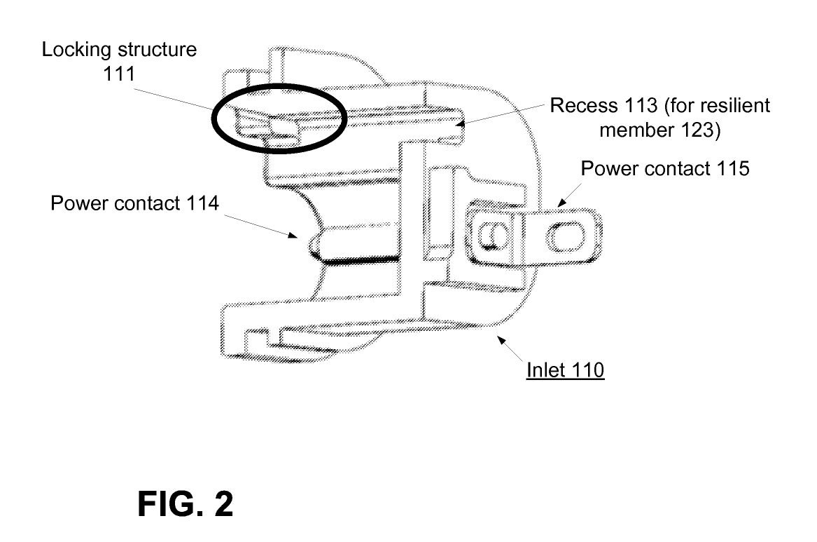

As mentioned, FIG. 1 depicts an illustrative embodiment of a slim lock connector system 100 in accordance with the present disclosure. FIG. 2 provides a sectioned rear view of the slim lock inlet 110.

As shown, the illustrative system includes a slim lock inlet 110, connector 120, outer mold 124, and cable 140. The inlet 110 comprises a mating port 112, first and second power contacts 114 (only one of which is visible in FIG. 1) as well as a ground contact 116 disposed within the mating port. The inlet of this embodiment further includes a locking structure 111 and recess 113 disposed within the mating port (see FIG. 2). A rear-facing power contact 115 is visible in both FIGS. 1 and 2. The rear-facing contact 115 is electrically connected to one of the power contacts 114, and a second rear-facing contact (not shown) is similarly electrically connected to the other power contact. As can be appreciated by those skilled in the art, these rear-facing contacts as well as a rear-facing ground contact are designed to be coupled to appropriate contacts of a computer or other electronic appliance (not shown) to which power is to be supplied.

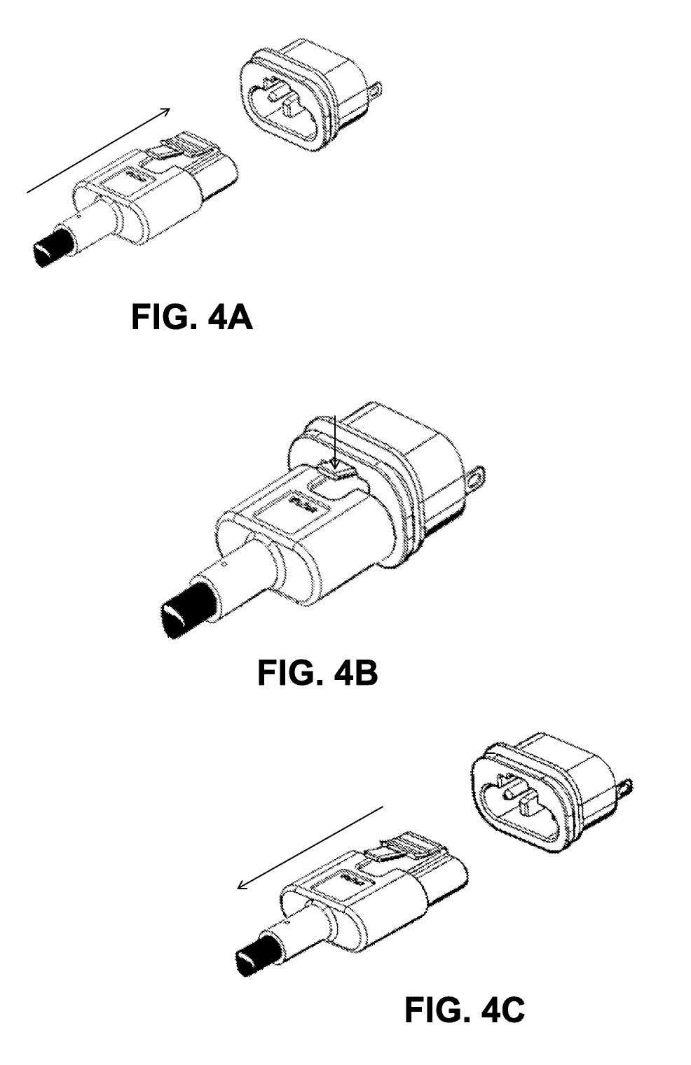

The assembly making up the connector 120 is configured to be removably engaged with and locked to the inlet 110 via the mating port 112. This assembly includes an outer mold 124 configured to encase the power and ground conductors and wires of a power cable 140. In addition, the assembly 120 includes a housing 121, release tab 122, and resilient member 123 coupled to the housing and release tab. The release tab 122 and resilient member 123 are formed of a material, such as a plastic, that is sufficiently flexible to enable the resilient member to be depressed by a user repeatedly without breaking, but sufficiently rigid so as to form a firm lock for the connector when locked within the inlet 110. The release tab 122 and resilient member 123 are configured such that pressing on the release tab 122 enables the housing 121 to be unlocked from the inlet 110. (See FIG. 4.) It can be seen that the inlet 110 is designed such that the mating port 112, locking structure 111, recess 113, power contacts 114, and ground contact 116 are configured to enable the connector 120 (including the housing 121, release tab 122, and resilient member 123) to be removably engaged with and locked to the inlet via the mating port 112.

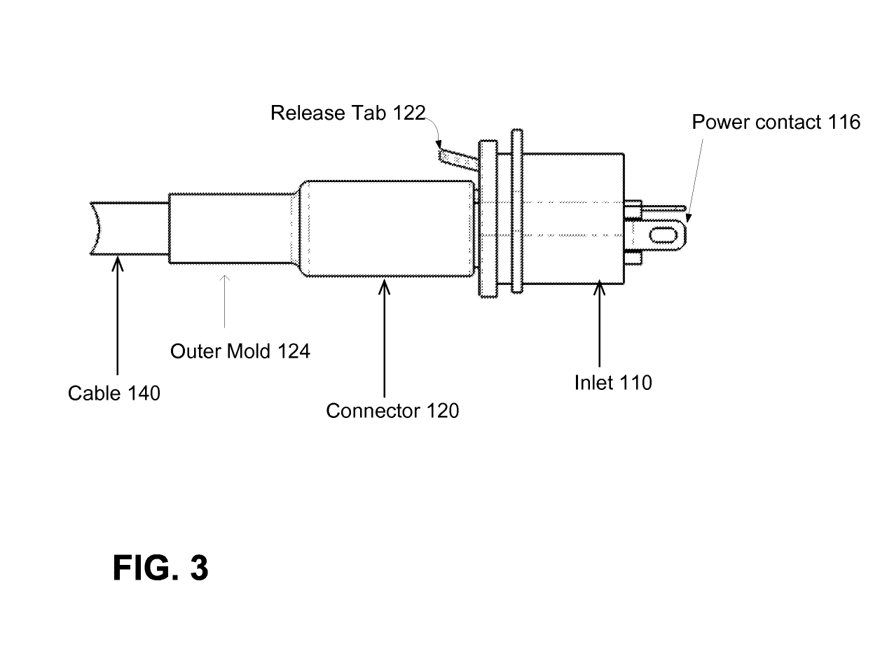

FIG. 3 depicts another view of the slim lock connector system. In this view, connector 120 is fully inserted into inlet 110. In this configuration, the resilient member (not pictured in FIG. 3) has passed beyond the locking structure (not pictured in FIG. 3) such that the resilient member has snapped into place into the recess (not pictured in FIG. 3). With the resilient member released into the recess and behind the locking structure, the connector is locked inside the inlet. The release tab 122, being connected to the resilient member has also snapped into place, and is ready to be pressed down again to release the connector 120 from the inlet 110. Power contacts 116 on the inlet 100 enable connection with, for example, a mobile electronic device that inlet 110 has been mounted on. Cable 140 comes out of the outer mold 124 of connector 120, and may lead to, for example, a power source or other electronic device.

FIGS. 4A, 4B, and 4C illustrate steps for engaging and disengaging the connector 120 and the inlet 110. To engage the connector, as shown in FIG. 4A, the user simply aligns and inserts the connector 120 into the inlet 110 with sufficient force or pressure to cause the resilient member 123 to deflect when it comes into contact with the locking structure 111. When the connector 120 is fully inserted into the mating port 112, the deflected resilient member 123 will pass beyond locking structure 111, and will revert to its non-deflected form, snapping into place behind the locking structure 111. The connector 120 is now locked in place until purposely disengaged. To disengage, the user simply presses down on the release tab 122, as illustrated in FIG. 4B, before pulling the connector 120 away from the inlet 110, as illustrated in FIG. 4C.

Although embodiments of the present disclosure have been illustrated in conjunction with the accompanying drawings and described in the foregoing detailed description, it should be appreciated that the invention is not limited to the embodiments disclosed and is capable of numerous rearrangements, modifications, alternatives, and substitutions without departing from the spirit of the disclosure as set forth and recited by the following claims.

What is claimed:

1. A connector system, comprising:
an inlet comprising a mating port, first and second power contacts disposed within the mating port, and a ground contact disposed within the mating port; and
a connector configured to be removably engaged with and locked to the inlet via the mating port.

2. The connector system recited in claim 1, wherein the inlet further comprises a locking structure and recess disposed within the mating port.

3. The connector system recited in claim 2, wherein the connector comprises a housing release tab and resilient member coupled to the housing and release tab.

4. The connector system recited in claim 3, wherein the release tab and resilient member are configured such that pressing on the release tab enables the housing to be unlocked from the inlet.

5. An inlet, comprising:
a mating port;
a locking structure and recess disposed within the mating port;
first and second power contacts disposed within the mating port; and
a ground contact disposed within the mating port.

6. The inlet recited in claim 5, wherein the mating port, locking structure, recess, power contacts, and ground contact, are configured to enable a connector to be removably engaged with and locked to the inlet via the mating port.

7. A connector, comprising a housing, release tab, and resilient member, wherein the resilient member is coupled to the housing and the release tab, wherein the connector is configured to be removably engaged with and locked to an inlet via a mating port of the inlet.

8. The connector recited in claim 7, wherein the release tab and resilient member are configured such that pressing on the release tab enables the housing to be unlocked from the inlet.
